(19) United States
(12) Patent Application Publication
(10) Pub. No.: US 2024/0253068 A1
(43) Pub. Date: Aug. 1, 2024

(54) ADHESIVE SPRAY NOZZLE AND METHODS OF USING THE SAME

(71) Applicant: 3M INNOVATIVE PROPERTIES COMPANY, St. Paul, MN (US)

(72) Inventors: Andrew W.G. Horvath, North St. Paul, MN (US); Michael D. Zenner, Hudson, WI (US); Ryan D. Erickson, Roseville, MN (US); William J. Feil, III, Woodbury, MN (US); Ryan K. McKenney, Roseville, MN (US); Dillon Gentekos, St. Paul, MN (US)

(21) Appl. No.: 18/427,104

(22) Filed: Jan. 30, 2024

Related U.S. Application Data
(60) Provisional application No. 63/482,401, filed on Jan. 31, 2023.

(51) Int. Cl. B05B 1/30; B05B 1/22; B05B 9/03

(52) U.S. Cl. CPC B05B 1/3046; B05B 1/22; B05B 9/03

(57) ABSTRACT

An adhesive spray nozzle, comprising a nozzle tip having a deflector mounted on the nozzle tip adjacent the spray adhesive outlet, where the deflector includes angled surfaces configured to impinge upon the adhesive spray exiting the outlet for spray adhesive.

### BACKGROUND

A variety of adhesive nozzles and a variety of applicators are known in the art. Some examples include: U.S. Pat. No. 9,174,231, titled “Sprayer Fluid Supply with Collapsible Liner; European Pat. No. 2760759 A2, titled “Systems and Methods for Dispensing one or more Liquids from a portable Self-Contained Apparatus;” and U.S. Pat. No. 7,713,365, titled “Water Based Aerosol Adhesive.” Other examples include: U.S. Pat. Publication No. 2019/0308201 A1, titled “Spray Gun and Nozzle Assembly Attachment;” and PCT Publication No. WO 2018/109624, titled “Spray Gun and Nozzle Assembly Attachment.”

### SUMMARY

One aspect of the present invention provides an adhesive spray nozzle comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive connected at a first end of the nozzle tip including a spray adhesive orifice; a deflector mounted on the first end of the nozzle tip adjacent the spray adhesive outlet, wherein the deflector comprises a first angled surface and a second angled surface, wherein the first angled surface and second angled surface are configured to impinge upon the adhesive spray exiting the outlet for spray adhesive.

Another aspect of the present invention provides an alternative adhesive spray nozzle comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive in the first end of the nozzle tip, wherein the outlet includes a spray adhesive orifice; a deflector mounted on the first end of the nozzle tip adjacent the spray adhesive outlet, wherein the deflector comprises a first angled surface and a second angled surface, wherein the first angled surface is connected to the orifice for spray adhesive so as to bisect the orifice and wherein second angled surface is connected to the orifice for spray adhesive to bisect the orifice.

Another aspect of the present invention provides yet another adhesive spray nozzle comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive connected at a first end of the nozzle tip including a spray adhesive orifice; a deflector mounted on the first end of the nozzle tip adjacent the spray adhesive outlet, wherein the deflector comprises a first angled surface and a second angled surface, wherein the first angled surface includes a curved portion and second angled surface includes a curved portion.

Another aspect of the present invention provides yet another adhesive spray nozzle comprising: a barrel having a first end and second end opposite the first end; a nozzle tip having a first end and a second end opposite the first end, wherein the second end of the nozzle tip is connected at a first end of the barrel; a conduit for pressurized adhesive having an inlet and an outlet opposite the inlet, wherein the outlet is connected within the barrel, and wherein the conduit includes a first curved surface and a second curved surface for restricting the width of the outlet; an outlet for spray adhesive connected at a first end of the nozzle tip including a spray adhesive orifice.

Yet another aspect of the present invention provide a method of spraying adhesive comprising: supplying pressurized adhesive; propelling the pressurized adhesive down a conduit to form a first adhesive flow path; impinging the pressurized adhesive with a first curved surface and a second curved surface with an open slit therebetween, whereby the pressurized adhesive exits the conduit through the slit; thereafter propelling the pressurized adhesive through a second conduit to form a second adhesive flow path; impinging the pressurized adhesive with a first angled surface and a second angled surface with a slit therebetween; and forming a focused fan-shaped spray of pressurized adhesive.

### BRIEF DESCRIPTION OF THE DRAWINGS

FIG. 1 is a perspective view of one embodiment of the adhesive spray nozzle of the present invention;

FIG. 2 is a side view of the nozzle of FIG. 1;

FIG. 3 is a front view of the nozzle of FIG. 1;

FIG. 4 is a top view of the nozzle of FIG. 1;

FIG. 4A is a magnified view of the adhesive conduit of FIG. 4 taken within circle 4A.

FIG. 5 is a cross-sectional view of the nozzle of FIG. 4 taken along line 5-5;

FIG. 6 is a tilted view of the cross-sectional view of the nozzle of FIG. 4 taken along line 5-5;

FIG. 7 is a magnified view of the nozzle tip of FIG. 3 taken within circle 7;

FIG. 8 is a top view of the nozzle of FIG. 5;

FIG. 9 is a cross-sectional view of the nozzle of FIG. 4 taken along line 9-9;

FIG. 9A is a magnified view of the deflector of the nozzle within circle 9A of FIG. 9;

FIG. 9B is a magnified view of the orifice viewed from inside the nozzle taken along lines 9B-9B of FIG. 4;

FIG. 10 is magnified view of the deflector of the nozzle of FIG. 9 taken along line 10-10;

FIG. 11 is a cross-sectional view of an applicator assembly convenient for use with the nozzle of FIG. 1;

FIG. 12A is an Ansys model as detailed in the Examples section; and

FIG. 12B is Ansys model of adhesive flow through the nozzle of the present invention as detailed in the Examples section.

### DETAILED DESCRIPTION

As the market shifts towards more sustainable and environmentally friendly adhesives, such as water-based adhesives, it is preferable to consider alternative designs for adhesive nozzles. Unlike solvent based adhesives which often can self-purge and clean the nozzle, water-based adhesives typically can suffer from the inability to easily clean the nozzles or affiliated spray applicators used to apply the adhesive. The spray nozzle of the present invention and associated applicator provides a unique design including certain configurations and internal geometries that were specifically developed to provide a superior spray performance of adhesives, while providing an easy to clean, economical nozzle and applicator. The nozzle is designed to be easily replaced thus enabling a quick changeover for any spray pattern issues in a few minutes, verses an hour or more to clean a conventional applicator traditionally used for solvent-based adhesives. The nozzle is disposable. Another advantage of the nozzle and applicator is the reduced clean up time and low to no need for cleanup solutions such as solvents, which are typically required for conventional spray guns. Additionally, the design of the spray nozzle allows for the dispensing of low to zero VOC adhesives without the use of liquid propellants, making it an airless nozzle. The spray nozzle of the present invention also provides a controlled spray pattern through use of its internal diameters and reduction or choke points. Optimized turbulent flow is achieved in the spray nozzle by mechanical breakup and use of certain helical sections within the nozzle. The spray nozzle of the present invention includes a specially designed deflector, which deflects the spray as it is exiting the nozzle. Lastly, dead space within the nozzle is minimized by configuring the inlet of spray adhesive into the nozzle through use of certain design features. Overall, the nozzle of the present invention delivers an improved spray pattern through use of its design by providing more uniform flow through the nozzle, coupled with use of its unique deflector.

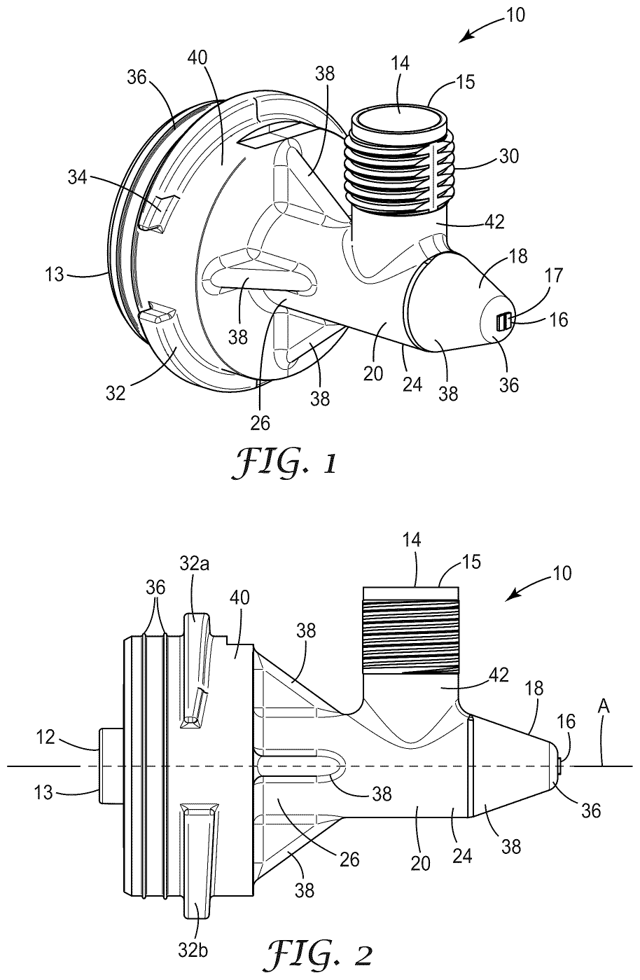

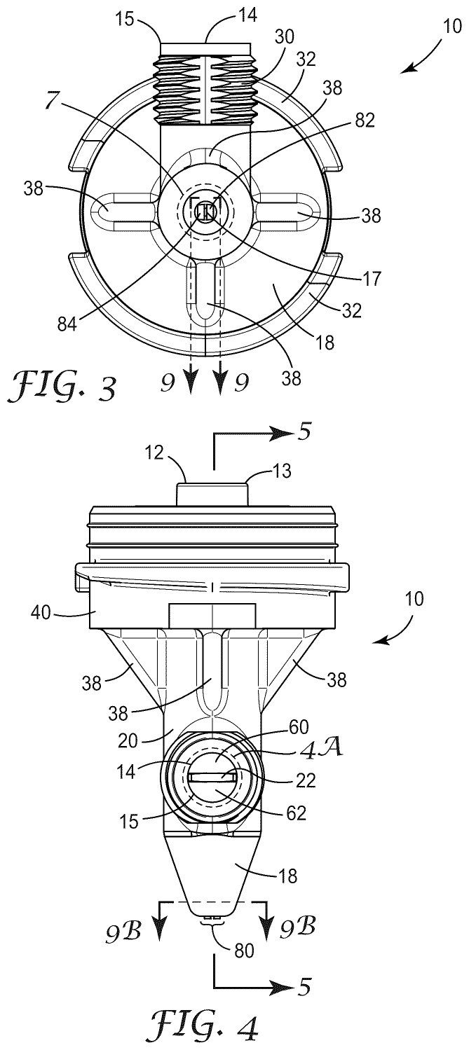

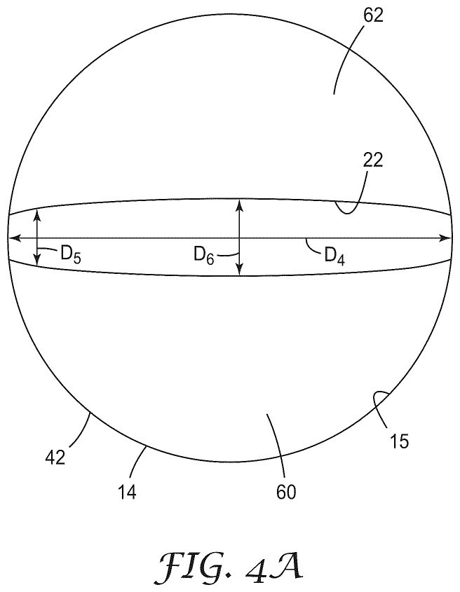

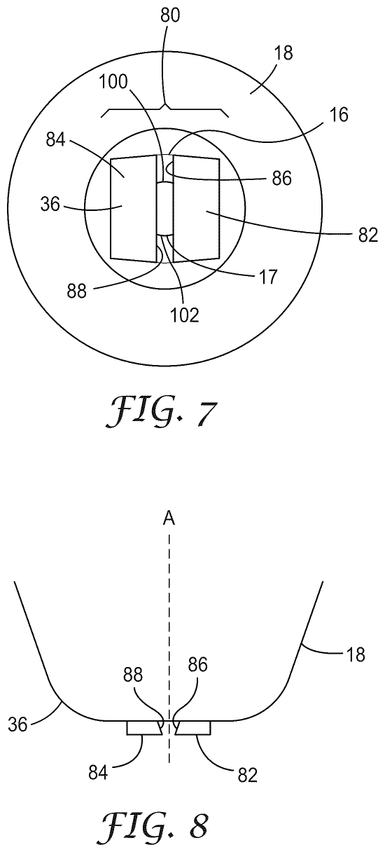

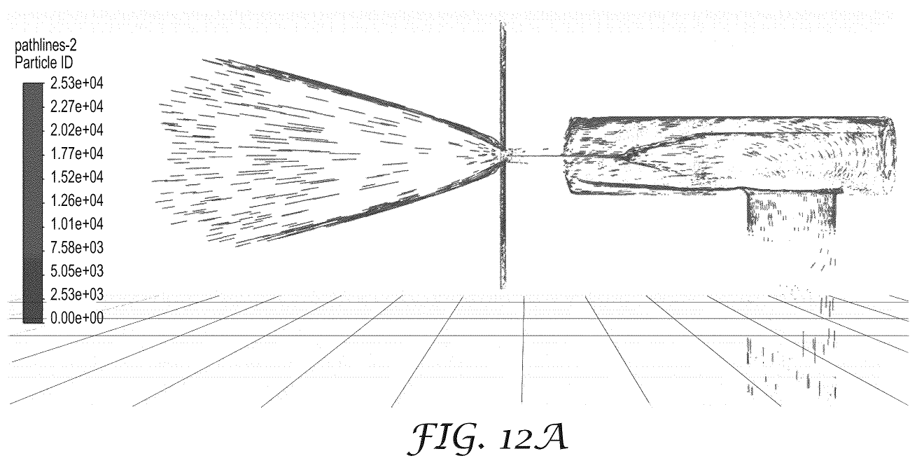

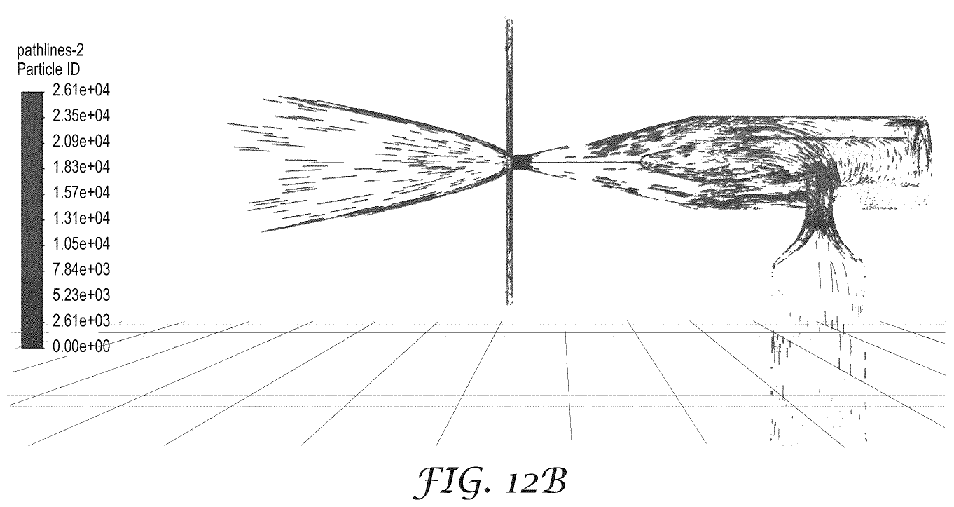

FIGS. 1-10 illustrate multiple views and cross-sectional views of one embodiment of the spray nozzle 10 of the present invention having a centered axis A. FIGS. 1-4 are convenient for illustrating the overall nozzle 10. FIGS. 4A-6 are convenient for illustrating the adhesive conduit 42 and portions inside the nozzle 10. FIG. 6 is also convenient for illustrating the adhesive flow inside the nozzle 10. FIGS. 7-10 are convenient for illustrating one embodiment of a deflector 80 on the nozzle 10. FIG. 11 is convenient for illustrating the nozzle 10 as part of an applicator assembly 120. FIGS. 12A and 12B illustrate simulations illustrating the benefits of the nozzle 10 of the present invention.

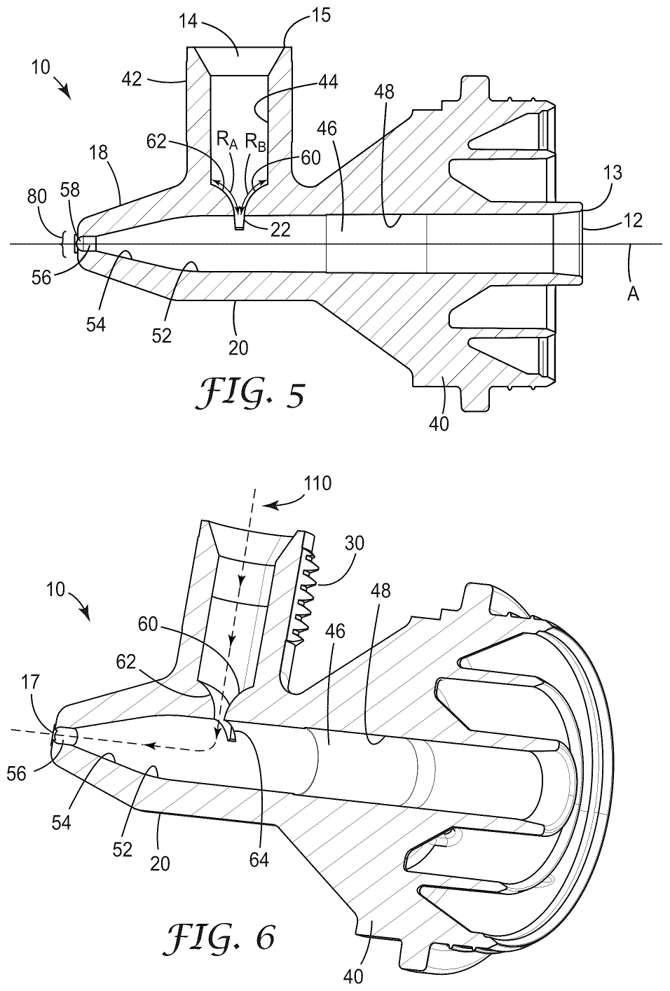

As shown best in FIGS. 1-4, the nozzle 10 includes a collared portion 40, a barrel portion 20, and a tapered nozzle tip 18. The barrel portion has a first end 24 and a second end 26 opposite the first end. The nozzle tip 18 has a first end 36 and a second end 38 opposite the first end. The first end 24 of the barrel portion 20 connects to the second end 38 of the nozzle tip 18. The barrel portion 20 is in fluid communication with the nozzle tip 18, as best shown in FIGS. 5 and 6. The second end 26 of the barrel portion 20 connects to the collared portion 40. The barrel portion 20 includes multiple supports 38 externally connecting the barreled portion 20 to the collared portion 40. The collared portion 40 includes camming members 32, and tabs 34 for connecting the nozzle 10 to the applicator assembly 120 (as shown in FIG. 11). The collared portion 40 includes an inlet 12 having an orifice 13. The tip portion 18 includes an outlet for spray adhesive 16, which has a spray orifice 17. The tip portion 18 also includes a deflector 80 mounted adjacent the spray orifice 17, discussed in more detail relative to FIGS. 7-10 below.

FIGS. 5 and 6 illustrate other aspects of the nozzle 10. The nozzle 10 also includes an adhesive conduit 42 which is in fluid communication with the barrel portion 20. The adhesive conduit 42 includes an inlet for adhesive 14 having an orifice 15. The adhesive conduit 42 also includes threads 30 located externally on the conduit 42 for attaching the nozzle 10 to a pressurized adhesive source such as a hose 116, as illustrated in FIG. 11. Within the adhesive conduit, the flow path of pressurized adhesive 110 is designed to be restricted by two curved surfaces, 60, 62. The flow path of pressurized adhesive is restricted from the diameter provided by the inner surface 44 to an outlet 22 in the shape of a slit which is narrower and is formed between the first curved surface 60 and second curved surface 62.

In one embodiment of the nozzle 10, the diameter of the adhesive conduit 42 is preferably in the range of 0.24-0.26 inches (0.6096-0.6604 cm) and more preferably in the range of 0.247-0.249 inches (0.6274-0.6325 cm).

FIG. 4A offers a magnified view of the inside of the adhesive conduit 42 discussed above, offering certain measurements of distances D relative to the specially designed slit formed between the first curved surface and the second curved surface 62. Distance D₄ is measuring the horizontal axis is in the range of 0.15-0.25 inches (0.381-0.635 cm), and more preferably 0.19-0.21 inches (0.4826-0.5334 cm). Distance D₅ is measuring the narrowest vertical axis is in the range of 0.025-0.035 inches (0.0635-0.0889 cm), and more preferably 0.032-0.035 inches (0.0813-0.0889 cm). Distance D₆ is measuring the widest vertical axis is in the range of 0.030-0.050 inches (0.0762-0.127 cm) and more preferably 0.040-0.045 inches (0.1016-0.1143 cm).

As illustrated in FIGS. 4A, 5 and 6, the slit outlet 22 is formed between the first and second curved surfaces 60, 62. The slit outlet 22 is also semicircular in shape due to being cut into the cylindrical inner surface 48 of conduit 46, but has a uniform width. In one embodiment of the nozzle 10, regarding the first and second curved surfaces 60, 62, each may include a particular radius R_{A} and R_{B} for their respective radiuses of curvature. For example, both R_{A} and R_{B} may include a radius of curvature in the range of approximately 0.1000-0.2000 (0.254-0.508 cm), and more preferably in the range of 0.1400-0.1500 inches (0.3556-0.3810 cm) for curved surfaces 60, 62. However, R_{A} and R_{B} could have alternative different for radiuses of curvature so long as the distance between the curved surfaces 60, 62 provides the slit outlet 22 that is desired. This design in the reduction of the overall volume of flow of adhesive from orifice 15 to slit outlet 22 assists in reducing down and better controlling the spray adhesive ultimately exiting the spray orifice 17 in the nozzle 10.

As shown best in FIGS. 5 and 6, barrel portion 20 and collared portion 40 include a conduit 46 having an inner surface 48. The conduit 46 tapers from a cylindrical portion 52 into a conical portion 54 and then tapers into another cylindrical portion 56, and then tapers into a hemispherical portion 58. In one embodiment of the nozzle 20, the cylindrical portion 52 of conduit 46 includes a diameter measured along its inner surface 48 is in the range of 0.2300-0.2600 inches (0.5842-0.6604 cm), and more preferably 0.2400-0.2500 inches (0.6096-0.6350 cm). In the conical portion 54, the diameter ranges from 0.2500-0.0600 inches (0.6350-0.1524 cm) from its max to min diameter, and more preferably 0.2450-0.0610 inches (0.6223-0.1549 cm). The semi-circle portion 52 includes a diameter of 0.0600-0.0650 inches (0.1524-0.1651 cm), and more preferably 0.0610 to 0.0630 inches (0.1549-0.1600 cm). The conduit 46 is sized to receive a needle member 126, best shown in FIG. 11. The needle member 126 is designed to move down center axis A through the conduit 46 to first shut off the slit 64 where the pressurized adhesive is flowing through adhesive conduit 42 along adhesive flow path 110, and then to contact the surfaces 52, 54, 56 to shut off the adhesive flow 110 exiting the nozzle tip 18 at orifice 17.

FIGS. 7-9, 9A, 9B, and 10 are all convenient for illustrating the specially shaped orifice 17 in the nozzle tip 18 and the deflector 80 mounted on the first end 36 of the nozzle tip 18 adjacent the adhesive orifice 17. The deflector 80, in combination with the specifically shaped orifice 17, are specially designed to provide a fan-shaped and focused water-based spray exiting the nozzle 10.

As illustrated in FIGS. 7-9 and 9A, a specially designed deflector 80 is mounted on the tip portion 18. In this embodiment, the deflector 80 includes a first portion 82 and a second portion 84. First portion 82 and second portion 84 are mounted adjacent from each other relative to the orifice 17. First portion 82 includes a first angled surface 86. Second portion includes a second angled surface 88. The first angled surface 86 is connected to the spray orifice 17 for spray adhesive so as to bisect the orifice 17. Likewise, the second angled surface 88 is connected to the orifice 17 spray adhesive to bisect the orifice 17. In fact, the first angled surface 86 and second angled surface 88 may be mirror images of one another and centered relative to one another along axis A of the nozzle 10. The angled surfaces 86, 88 are configured to be at certain angles α measured relative to the axis A of nozzle 10, which is centered from the center of the nozzle orifice 17 in the tip portion 18 to the center of the orifice 13 of the collared portion 40. In one embodiment of the nozzle 10, the angled surfaces 86, 88 are an at angle α is in the range of 5-10 degrees. In a more preferred embodiment, angle α is in the range of 7-10 degrees.

The angled surfaces 86, 88 of the deflector 80 reduce the width of the adhesive spray from the width W_{b} to a narrower width of Wₜ. In one particular embodiment of the nozzle 10, width W_{b} is between 0.015-0.025 inches (0.0381-0.0635 cm) and width Wₜ is between 0.010-0.025 inches (0.0254-0.0635 cm). In a preferred embodiment, width W_{b} is between 0.018-0.023 inches (0.0457-0.0584 cm) and width Wₜ is between 0.011-0.014 inches (0.0279-0.0.0356 cm). In one specific embodiment, width W_{b} is 0.0212 inches (0.0539 cm) and width Wₜ is 0.0122 inches (0.0309 cm). In another specific embodiment, width W_{b} is 0.0221 inches (0.05613 cm) and width Wₜ is 0.0189 inches (0.04801 cm).

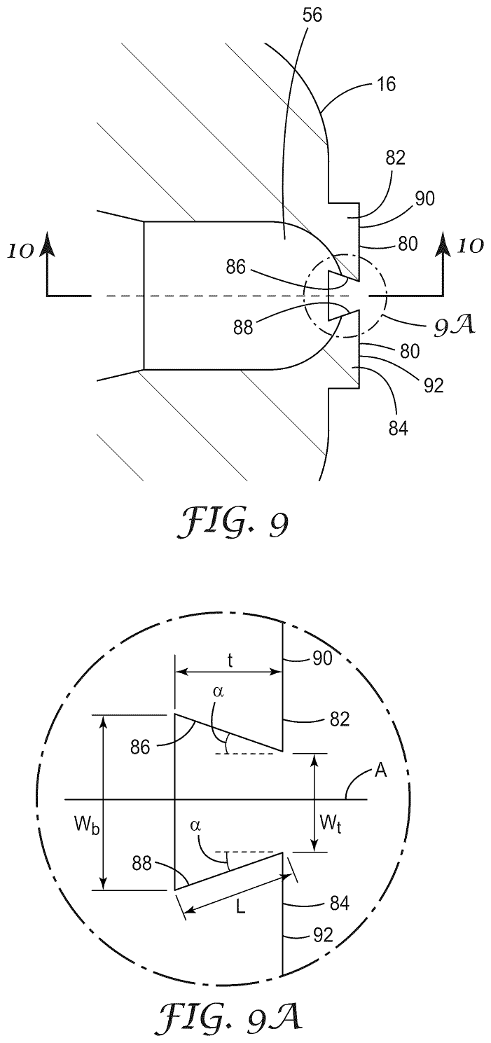

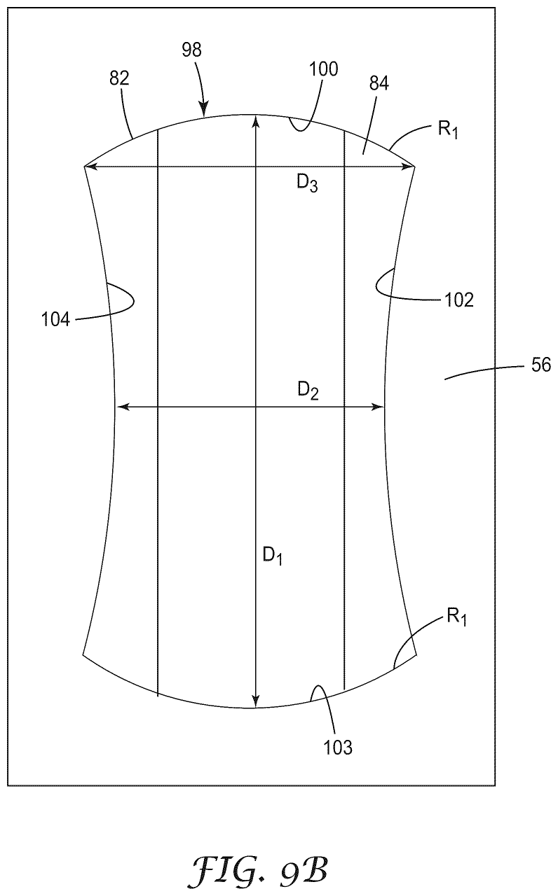

The measurements of the deflector 80 include certain preferred ranges. For example, length L of the angled surfaces 86, 88 illustrated in FIG. 9A may be in the range of 0.010-0.020 inches (0.0254-0.0508 cm). In a more preferred embodiment length L of the angled surfaces 86, 88 may be in the range of 0.011-0.015 inches (0.0279-0.0381 cm.). Distance denoted by letter “t” illustrated in FIG. 9A measuring the distance between the first and second front surfaces 90, 92 of the first and second portions 82, 84, respectively and the center of orifice 17 may be in the range of 0.010-0.020 inches (0.0254-0.0508 cm) and more preferably in the range of 0.011-0.015 inches (0.0279-0.0381 cm).

FIG. 9B is a magnified, profile view of the orifice 17 of the nozzle 10. The orifice 17 includes a specially designed shape, specifically in the shape of a center portion of a hyperbolic paraboloid slit 98. The slit orifice 98 includes four sides: first curved portion 100, second curved portion 102, third curved portion 103, and fourth curved portion 104, as illustrated. The orifice slit 98 can be described as having certain measurements (D) and radiuses (R). For example, in one embodiment, D₁, which is the vertical axis distance between the opposed curved portions, first curved portion 100 and third curved portion 103 may be in the range of 0.035-0.045 inches (0.0889-0.1143 cm), and more preferably in the range of 0.037-0.041 inches 0.0940-0.1041 cm). In the embodiment, D₂, which is the horizontal axis minimum distance between closest opposed curved portions, second curved portion 102 and fourth curved portion 104 may be in the range of 0.010-0.020 inches (0.0254-0.0508 cm), and more preferably in the range of 0.0165-0.0185 inches (0.0419-0.0470 cm). In the embodiment, D₃, which is the horizontal axis maximum distance between closest opposed curved portions, second curved portion 102 and fourth curved portion 104 may be in the range of 0.015-0.025 inches (0.0381-0.0635 cm), and more preferably in the range of 0.019-0.023 inches (0.0483-0.0584 cm). In one preferred embodiment, D₁ may be 0.039 inches (0.09906 cm), D₂ may be 0.01737 inches (0.04412 cm), and D₃ may be 0.02123 inches (0.05392 cm). In one embodiment, the radius of the curvature R₁ of the curved surfaces 100, 103 is in the range of approximately 0.010-0.025 (0.0254-0.0635 cm), and more preferably in the range of 0.0150-0.0200 inches (0.0381-0.0508 cm). In one preferred embodiment, R₁ is 0.0195 inches (0.04953 cm). This design of the overall shape of the orifice 17 assists in reducing down the spray adhesive exiting the orifice, compared to a prior art circular or oval-shaped orifice in spray adhesive applicators.

The angled surfaces 86, 88 of deflector 80 are configured to impinge upon the adhesive spray that will exit the orifice 17. The first portion 82 also includes first front surface 90, which is at approximately 90 degrees relative to the first angled surface 86. The second portion 84 also includes second front surface 92, which is at approximately 90 degrees relative to the first angled surface 86.

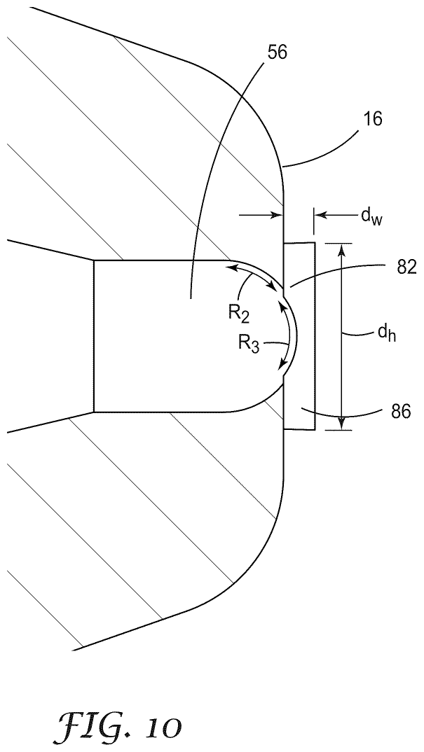

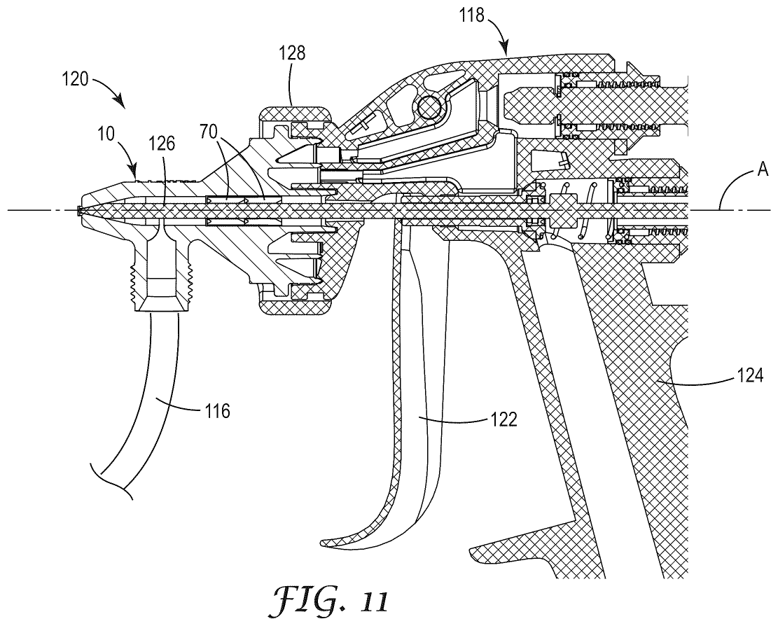

As shown best in FIG. 10, the first angled surface 86 of the first portion 82 of the deflector 80 include a height dₕ and a width d_{w}. Likewise, the second angled surface 88 of the second portion of the deflector (not illustrated) include the same height dₕ and a width d_{w}.

In one embodiment, preferred height dₕ is the range of 0.0600-0.0900 inches (0.1524-0.2286 cm), and a more preferred height dₕ is the range of 0.0700-0.0800 inches (0.1778-0.2032 cm). In another embodiment, preferred width d_{w} is the range of 0.010-0.020 inches (0.0254-0.0508 cm) and a more preferred width d_{w} in the range of 0.011-0.015 inches (0.0279-0.0381 cm).

FIG. 10 also helps illustrate the curved portion 94 in the first portion 82 of the deflector 80. Second portion 84 has a similar curved portion which mirrors the curved portion 94. The curved portions are shaped so that the first and second portions 82, 84 of the deflector 80 are abutted against the second curved portion 102 and fourth curved portion 104 of the partial hyperbolic slit orifice 98.

As illustrated in FIG. 10, the nozzle 10 includes two radiuses, R₂ and R₃, where one radius R2 is within the nozzle and other radius R3 is where the portions 82, 84 abut against the nozzle 10 near the slit orifice 98. In one embodiment, R₂ is in the range of 0.025-0.035 inches (0.0635-0.0889 cm), and R₃ is in the range of 0.020-0.030 inches (0.0508-0.0762 cm). In a more preferred embodiment, R₂ is in the range of 0.030-0.032 inches (0.0762-0.0813 cm) and R₃ is in the range of 0.023-0.027 inches (0.0584-0.0686 cm).

FIG. 11 illustrates the applicator assembly 120, which includes applicator 118 and nozzle 10 of the present invention. One suitable applicator 118 is commercially available from 3M Company based in St. Paul, Minnesota as 3M™ Performance Spray Gun System with PPS™ 2.0”, Part Number 7100228106. The applicator 118 includes a locking ring 128 for connecting with the collar portion 40 through use of camming members 32 and tabs 34. Two sealing members 70 are mounted with the nozzle 10 along the barrel portion 20 at the rear of the nozzle 10. These prevent adhesive flow towards the rear of the nozzle 10 and out the rear of the nozzle towards the applicator 118. These also retain the pressure between the sealing members 70 and the needle member 126 when the trigger 122 is not being depressed, thus allowing the adhesive flow to stop.

A source of pressurized adhesive (not shown) is connected to the nozzle 10 by use of hose 116. One preferred source(s) of pressurized adhesive is sold by 3M Company as 3M™ Fastbond™ Insulation Adhesive 49, Part number 7010329770. These types of adhesives work especially well with the design of the nozzle of the present design because they are water-based with appropriate sheer stability and high solids as compared to conventional solvent based products. When the applicator 118 and nozzle 10 are attached, the needle member 126 is in slidable engagement with conduit 46 of the barrel portion 20 along centered axis A. There is a mechanism for advancing or retracting the needle member 126 in the conduit 46 by use of the trigger 122 of the applicator 118. Applicator 118 also includes handle 124 for a user to hold the applicator assembly 120 while in use.

Various methods of using the nozzle of the present invention are now described. The nozzle 10 is connected to the applicator 118 via the locking ring 238 to provide an applicator assembly 120. Next a source of pressurized adhesive, such as 3M™ Fastbond™ Insulation Adhesive 49 in a canister, is connected to the nozzle 10 with use of a hose 116 via the adhesive conduit 42. The pressurized adhesive may then be propelled down the conduit 42 from a first adhesive flow path 110, by depressing the trigger 122 in the applicator 118. When the trigger 122 is depressed, the needle member allows the flow of water-based pressurized adhesive to flow from the adhesive conduit 42 and into barrel portion 20. As the pressurized adhesive flows from the conduit 42 into the barrel portion 20 impinges a first curved surface 60 and a second curved surface 60 and flows through the open slit therebetween, whereby the pressurized adhesive exits the conduit through the outlet slit 22, which significantly reduces the overall flow of the pressurized adhesive into the barrel portion 40, thus allowing more control. Afterwards, the pressurized adhesive continues through the barrel portion 40 down adhesive path 110. The pressurized adhesive flows down a nozzle conical portion and a spherical tip in the nozzle, where the flow is reduced even further, before it exits out of the orifice 15 in outlet 16. Since the spray adhesive orifice 15 is the shape of a hyperbolic paraboloid slit, it further reduces down the flow of pressurized adhesive. As the pressurized adhesive exits the orifice 15, it impinges the 86 first angled surface and a second angled surface 88 of the deflector 80, thus forming a focused fan-shaped spray of pressurized adhesive.

### EXAMPLES

The following abbreviations are used in this section: in=inch, ft=feet, mm=millimeter, cm=centimeter, m=meter, μm=micrometer, s=second, min=minute, kg=kilogram, PSI=pounds per square inch, mms⁻¹=millimeters per second, kN=kilonewton, mL=milliliters, mLs⁻¹=milliliters per second, RPM=revolutions per minute, ° F.=degrees Fahrenheit, ° C.=degrees Celsius, MPa=Megapascal, and kPa=kilopascal.

TABLE 1
Materials

| Abbreviation | Description |
|---|---|
| FASTBOND 49 | Liquid adhesive, obtained under the name |
| | “3M ™ FASTBOND ™ INDUSTRIAL ADHESIVE |
| | 49”, from 3M Company, St. Paul, MN |
| PINNACLE | Polypropylene resin, obtained under the trade |
| 3208 | designation “PINNACLE 3208”, from |
| | Pinnacle Polymers, Garyville, LA |
| PLASTICOMP | Long glass fiber reinforced homopolymer |
| LSF60 | polypropylene thermoplastic, obtained under |
| | the trade designation “PLASTICOMP LSF60-PP”, |
| | from PlastiComp, Winona, MN |
| ACCURA 25 | Polypropylene-like resin, obtained under trade |
| | designation “ACCURA 25”, from 3D systems |
| | Corporation, Pella, IA |

### Test Methods

### Nozzle Part Dimension Measurements

Nozzle parts made using SLA and molding processes described below were measured using an OGP Smartscope Flash 635 optical system (OGP, Rochester, NY) and a Vermont gate pin set (Model 101200400, Vermont Gage, Swanton, VT) (0.0610-0.2500 in, 0.0240-0.635 cm). The resulting dimensions of the nozzle parts can be found in Table 2.

### Spray Width Measurements

A cylinder system as described below containing a cylinder, an adhesive, a hose, an applicator, and a nozzle was assembled. The cylinder valve was fully opened, and the cylinder nozzle was held perpendicular to silver paper (Shamrock Retail Packaging E-8601 Silver Metallic Foil Paper (24 in×833 ft, 70 cm×254 m), Shamrock, Greensboro, NC) at 12 in ±3 in (30.5 cm+/−7.6 cm) away. The trigger was depressed, and the adhesive was sprayed along a parallel path. The adhesive was allowed to dry. The width of the spray pattern was then measured with a tape measure and the width recorded in inches (cm). Acceptable spray widths were recorded as between 4-14 in (10 cm-36 cm). Table 3 presents the results for spray width for Examples 1-10 (EX1-EX10).

### Spray Rate Test Method

The cylinder system described below was tared on a scale (Ohaus Model T31P scale, Ohaus, Parsippany, NJ). The cylinder system was then sprayed for 10 s. The cylinder system was then weighed again. The values were then multiplied by 6 to obtain measurements in kg/min sprayed, that were then recorded. Table 3 presents the results for spray rate for Examples 1-10 (EX1-EX10).

### Acceptable Spray Pattern Test Method

A spray pattern was characterized as “Acceptable” or “Not Acceptable” based on a spray profile as illustrated for example in FIG. 12A or 12B. FIG. 12A illustrates “Not Acceptable” and FIG. 12B illustrates “Acceptable”. Table 3 presents the results for Spray Pattern Acceptability for Examples 1-10 (EX1-EX10).

### Preparation of Cylinder System

A cylinder (DOT39 Non-Refillable Large Compressed Gas Cylinder with Bladder, Model W022-05-0003, Worthington Industries, Columbus, OH) was used for all spray experiments for Examples 1-10 (EX1-EX10). The cylinder had an upper and lower chamber with separate filling ports. The upper chamber was filled with 12.0±0.5 kg of 3M™ Fastbond™ Insulation Adhesive 49 (3M Company, St. Paul, MN) using a 2-stage diaphragm peristaltic pump (Model TDS-DYISHENG, DYI SHENG INDUSTRY CO., LTD, Taiwan). The adhesive weight was measured by placing the empty cylinder on a scale (Ohaus Model T31P, Ohaus, Parsippany, NJ) and measuring the weight before and after addition of the adhesive. The lower chamber was pressurized with nitrogen to a pressure of 250±5 PSI. The pressure was verified using a pressure gauge (Model 20W1005H02LXAP400 #, Ashcroft, Stratford, CT). Once filled, the cylinder was attached to an applicator, a “3M™ Performance Spray Gun System with PPS™ 2.0”, Part Number 7100228106 (3M Company, St. Paul, MN) using a 6 ft “3M™ Cylinder Adhesive Hose”, Part Number 7000046656 (3M Company, St. Paul, MN). Disposable nozzle parts for Examples 1-10 (EX1-EX10) described below were attached to the applicator prior to spraying adhesive.

### Nozzle Design and Spray Simulation

To design a nozzle of the present invention that exhibited an acceptable spray pattern, commercial code Ansys R2 2020 and Fluent (Ansys, Inc., Canonsburg, PA) was utilized to facilitate modeling tasks for simulations to screen and capture the effects of nozzle geometry configurations on how uniformly a resultant spray pattern would disperse over its entire spray width. A resultant spray pattern in a simulation was characterized as “Acceptable” or “Unacceptable”. An “Acceptable” pattern indicated that the simulated nozzle part geometry configuration would likely be an acceptable nozzle to produce.

FIG. 12A represents “Not Acceptable”, without the nozzle of the present invention providing inlet restriction, where it showed a generation of heavy bands at the top and bottom of the spray pattern which were unacceptable in applications. Specifically, the simulated model of adhesive flow through the prior art nozzle along with the spray pattern exiting the prior art nozzle for an unconstrained adhesive inlet showed higher concentration of adhesive at the edges of the spray pattern (also referred to as “banding” in the industry).

FIG. 12B represents “Acceptable”, with the nozzle 10 of the present invention, where it showed a more even flow internally and a more disperse and uniform flow from the nozzle. This helped generate a more uniform particle type spray that was acceptable in many applications. Specifically, the simulated model of the adhesives flow through the nozzle of the present invention showed lower concentration of adhesive at the edges of the spray pattern, thus resulting in a more even distribution of adhesive across the fan portion exiting the nozzle 10.

### Preparation of Nozzle Parts for Examples 1-6 (EX1-EX6)

Nozzle parts were made using a Stereolithography (SLA) 3D printing process (Polyjet J850 printer, Stratasys, Eden Prairie, MN) using a solid model generated in SolidWorks 2021 software (SolidWorks, Watham, MA) and feeding with ACURRA 25. The build volume was 380 mm long×380 mm wide×250 mm high, and the layer thickness was between 50-100 μm. The resulting dimensions of the parts for Examples 1-6 (EX1-EX6) are as shown in Table 2.

### Preparation of Nozzle Parts for Examples 7-10 (EX7-EX10)

This procedure was used to produce Examples 7-10 (EX7-EX10). The resulting dimensions of the parts for Examples 7-10 (EX7-EX10) are as shown in Table 2. A standard dedicated P20 steel mold base (Model number 1118-B-47-37-3, available from PCS Company, Sterling Heights, MI) with approximate outer dimensions of 457 mm long by 321 mm wide by 276 mm high was used in the construction of the mold. The mold base consisted of two halves (A and B-side halves), where injection occurred through the A-side half via sprue bushing. The mold base had integrated thermal transfer fluid channels, one injection location, and five ejector pins of varying sizes. The A-side half had 4 leader pins that were 22 mm in diameter and extended 210 mm from the outer surface of the mold half. The B-side half had corresponding bushings to receive the leader pins. The leader pins and bushings aligned the mold halves when closed and placed in standard locations. Further alignment was accomplished with 2 straight positioning sets (Model number TPNF20-11, Misumi Components, Schaumburg, IL 60173) which were located on each side of the main core and cavity inserts. The cavity detail was machined into P-20 tool steel with inserts using a computer numerical controlled (CNC) vertical milling machine center (Model number VF3, Haas Automation, Oxnard, CA). Each of the cavity inserts was approximately 108 mm long by 114 mm wide by 38 mm high. The ejector pins were placed in locations to effectively remove the part from the mold without leaving defects on the exterior of the part. The injection site was chosen to promote the proper filling of the part during the injection process while allowing clean trimming of the gate from the part. The mold press nozzle was offset 9.5 mm from the center of the mold base. The orifice size was 4 mm and fed a 6.3 mm diameter full-round runner and a 4.75 mm×3.2 mm ramped edge gate. Each half of the mold was clamped to the injection molding machine platens using corresponding steel clamps with approximate dimension of 160 mm long by 50 mm wide by 40 mm high. The steel blocks fit into notches on the mold and were bolted to the platens to securely hold the mold in place.

The spray nozzle mold was installed into an Ardburg injection molding machine (Model Number 370H 600-290, Arburg, Lossburg, Germany). Pinnacle 3208 and Plasticomp LSF60 plastic pellets were weighed at a 50:50 ratio and hand mixed at a specified percentage by mass. The blend of pellets was loaded into a Matsui PMD 3.0 hopper dryer and gravity-fed into the feed throat of the injection molding machine via a 30 mm orifice. The general molding process was as follows: Mold close, Injection, Pack/hold, Cooling/metering, Mold open, Ejection. Each of these process steps had key parameters that controlled how the machine worked. These parameters are described in detail as follows.

Mold close was the step where the A- and B-sides of the mold closed, traveling from 200 mm to 0 with profiled velocity ranging from 30-150 mms⁻¹ with 150 kN of clamping force. After lockup was achieved, hydraulic cores were ‘set’ using a machine interface, prior to injection. The injection of approximately 18.5 mL of plastic material occurred at a velocity of 25 mLs⁻¹ which resulted in a fill time of 0.75 s, and a maximum injection pressure of 460 bar (46 MPa). Next, the packing pressure was held at 350 bar (35 MPa) for 13.5 s. The molded part was then allowed to cool in the clamped mold for 12 s. Metering occurred for approximately 6 s, using 40 RPM and 2 bar (200 kPa) back pressure. The hydraulic core was then actuated to the ‘pull’ position. The mold then opened at a velocity ranging between 75-250 mms⁻¹ to a distance of 200 mm. Ejection pins were then actuated multiple times at a rate of 300 mms⁻¹, from 0 to 20 mm to eject the molded part.

Examples 7-10 (EX7-EX10) contained molded parts that were made using the cavity injection mold using the process described above. Example 7 (EX7) and Example 8 (EX8) were heated to 70° F. (21° C.), Example 9 (EX9) was heated to 90° F. (32° C.), and Example 10 (EX10) was heated to 170° F. (77° C.). Additionally for Example 8 (EX8), after the part was manufactured, the fan at the exit of the nozzle (referenced as inverted V) was sanded off with sandpaper (3M™ Wetordry™ Abrasive Sheet 213QA 229 mm×280 mm, P320, 02040, 3M Company, St. Paul, MN) to remove the deflector feature from the part. The resulting part was cleaned prior to spraying to remove the residual resin from the part and exit orifice.

TABLE 2

| | Adhesive | Adhesive | | Inner Bore | Inner Bore | | Exit Fan | Exit Fan | | Best Fit |
|---|---|---|---|---|---|---|---|---|---|---|
| | Port Inner | Port Outer | Adhesive | Diameter | Diameter | Exit Bore | Outer | Inner | Exit Fan | Exit |
| | Diameter in | Diameter in | Port Funnel | Vertical in | Horizontal | Diameter | Opening | Opening | Height in | Diameter |
| Description | (cm) | (cm) | Height in(cm) | (cm) | in (cm) | in (cm) | in (cm) | in (cm) | in (cm) | in (cm) |
| EX1 | 0.2441 | 0.3820 | 0.1395 | 0.249 | 0.248 | 0.0386 | 0.0140 | 0.019 | 0.0121 | 0.0393 |
| | (0.6220) | (0.9703) | (0.3544) | (0.633) | (0.630) | (0.0980) | (0.0357) | (0.0483) | (0.0308) | (0.0999) |
| EX2 | 0.2458 | 0.3886 | 0.1232 | 0.253 | 0.250 | 0.0376 | 0.014 | 0.0188 | 0.0122 | 0.0376 |
| | (0.6244) | (0.9870) | (0.3130) | (0.6426) | (0.640) | (0.0954) | (0.0358) | (0.0478) | (0.0311) | (0.0954) |
| EX3 | 0.2457 | 0.3824 | 0.1202 | 0.250 | 0.249 | 0.0597 | 0.0151 | 0.0184 | 0.0116 | 0.0547 |
| | (0.6240) | (0.9870) | (0.3053) | (0.635) | (0.633) | (0.1517) | (0.0383) | (0.0467) | (0.0295) | (0.1390) |
| EX4 | 0.2448 | 0.3880 | 0.1240 | 0.249 | 0.248 | 0.0379 | 0.0184 | 0.0214 | 0.0126 | 0.0358 |
| | (0.6217) | (0.9854) | (0.3151) | (0.6325) | (0.630) | (0.096) | (0.0468) | (0.0544) | (0.0319) | (0.0910) |
| EX5 | 0.2461 | 0.3861 | 0.1215 | 0.249 | 0.249 | 0.0385 | 0.0189 | 0.0219 | 0.0122 | 0.0378 |
| | (0.6250) | (0.9808) | (0.3085) | (0.633) | (0.633) | (0.0978) | (0.0480) | (0.0557) | (0.0310) | (0.0959) |
| EX6 | 0.2452 | 0.3835 | 0.1218 | 0.248 | 0.248 | 0.0380 | 0.0145 | 0.0190 | 0.0119 | 0.0359 |
| | (0.6228) | (0.9741) | (0.3093) | (0.630) | (0.630) | (0.0965) | (0.0369) | (0.0482) | (0.0302) | (0.0913) |
| EX7 | 0.2498 | 0.3943 | 0.1306 | 0.252 | 0.254 | 0.0399 | 0.0160 | 0.0221 | 0.0133 | 0.0299 |
| | (0.6345) | (1.0014) | (0.3317) | (0.640) | (0.645) | (0.1014) | (0.0406) | (0.0562) | (0.0338) | (0.0758) |
| EX8 | 0.2498 | 0.3943 | 0.1306 | 0.252 | 0.254 | 0.0399 | n/a | n/a | n/a | 0.0299 |
| | (0.6345) | (0.9741) | (0.3093) | (0.640) | (0.645) | (0.1014) | | | | (0.0758) |
| EX9 | 0.2503 | 0.3933 | 0.1333 | 0.252 | 0.254 | 0.0395 | 0.0160 | 0.0221 | 0.0125 | 0.0297 |
| | (0.6358) | (0.9991) | (0.3387) | (0.640) | (0.645) | (0.1002) | (0.0408) | (0.0561) | (0.0317) | (0.0755) |
| EX10 | 0.2517 | 0.3942 | 0.1265 | 0.252 | 0.250 | 0.0395 | 0.0157 | 0.0211 | 0.0137 | 0.0280 |
| | (0.6393) | (1.0012) | (0.3213) | (0.640) | (0.645) | (0.1004) | (0.0399) | (0.0537) | (0.0348) | (0.0711) |

TABLE 3
Spray Width and Spray Rate Measurements
and Spray Pattern Acceptability

| | Spray | Spray | |
|---|---|---|---|
| | Width | Rate | |
| | in | kg/min | Spray Pattern |
| Description | (cm) | (kg/10 s) | Acceptability |
| EX1 | 14 | 1.2 | Acceptable |
| | (35.5) | (0.200) | |
| EX2 | 11.5 | 1.1 | Acceptable |
| | (29.2) | (0.183) | |
| EX3 | 14 | 1.55 | Acceptable |
| | (35.5) | (0.258) | |
| EX4 | 4 | 0.8 | Acceptable |
| | (10.2) | (0.133) | |
| EX5 | 7 | 1.0 | Acceptable |
| | (17.8) | (0.167) | |
| EX6 | 7 | 0.75 | Acceptable |
| | (17.8) | (0.125) | |
| EX7 | 4 | 0.95 | Acceptable |
| | (10.2) | (0.158) | |
| EX8 | 1 | 1.6 | Not Acceptable |
| | (2.54) | (0.267) | |
| EX9 | N/A | 0.85 | Acceptable |
| | | (0.142) | |
| EX10 | N/A | 0.85 | Acceptable |
| | | (0.142) | |

### SELECT EMBODIMENTS OF THE PRESENT DISCLOSURE

Embodiment 1 is an adhesive spray nozzle, comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive connected at a first end of the nozzle tip including a spray adhesive orifice; a deflector mounted on the first end of the nozzle tip adjacent the spray adhesive outlet, wherein the deflector comprises a first angled surface and a second angled surface, wherein the first angled surface and second angled surface are configured to impinge upon the adhesive spray exiting the outlet for spray adhesive.

Embodiment 2 is the nozzle of Embodiment 1, wherein the nozzle has an axis A centered along the outlet for spray adhesive, and wherein the first angled surface and second angled surface are both at the same angle α measure relative to axis A.

Embodiment 3 is the nozzle of Embodiment 2, wherein the first angled surface and second angled surface are both at an angle α in the range of 5 to 10 degrees relative to the centered axis A.

Embodiment 4 is the nozzle of Embodiment 3, wherein the first angled surface and second angled surface are both at an angle α in the range of 7 to 10 degrees relative to the centered axis A.

Embodiment 5 is the nozzle of Embodiment 1, wherein the spray adhesive orifice is in the shape of a slit.

Embodiment 6 is the nozzle of Embodiment 5, wherein the spray adhesive orifice slit is in the shape of a hyperbolic paraboloid slit.

Embodiment 7 is the nozzle of Embodiment 6, wherein the nozzle has an axis A centered along the hyperbolic paraboloid slit orifice, and wherein the first angled surface and second angled surface are both at an angle α in the range of 5 to 10 degrees relative to the centered axis A.

Embodiment 8 is the nozzle of Embodiment 7, wherein the hyperbolic paraboloid slit orifice has a horizontal axis in the range of 0.035 to 0.045 inches (0.0889 to 0.1143 cm) and has vertical axis of 0.015 to 0.025 inches (0.0381 to 0.0635 cm) at its widest measurement.

Embodiment 9 is the nozzle of Embodiment 1, wherein the first and second angled surface both have a length L measured from the orifice of 0.010 to 0.020 inches (0.0254 to 0.0508 cm).

Embodiment 10 is the nozzle of Embodiment 1, wherein the deflector includes a first front surface on the first portion and a second front surface on the second portion, and wherein the first front surface and second front surface are normal to a centered axis A of the nozzle.

Embodiment 11 is the nozzle of Embodiment 1, wherein the first angled surface is connected to the spray adhesive orifice so as to bisect the orifice and wherein second angled surface is connected to the orifice for spray adhesive to bisect the orifice.

Embodiment 12 is the nozzle of Embodiment 1, wherein the first angled surface and second angled surface are mirror images of one another, and centered relative to an axis A of the nozzle.

Embodiment 13 is the nozzle of Embodiment 1 further comprising an adhesive conduit, wherein the inlet for pressurized adhesive is within the adhesive conduit, wherein the adhesive conduit includes a first curved surface and a second curved surface for restricting the flow of pressurized adhesive into the barrel.

Embodiment 14 is the nozzle of Embodiment 13, wherein the first curved surface and second curved surface form a slit therebetween.

Embodiment 15 is an applicator assembly comprising and applicator and the adhesive spray nozzle of Embodiment 1.

Embodiment 16 is an applicator assembly of Embodiment 15 further comprising a needle member slidably mounted inside the barrel and a trigger for moving the needle member within the barrel.

Embodiment 17 is the applicator assembly of Embodiment 1, further comprising a source of water-based pressurized adhesive, wherein the source is connected to the conduit for pressurized adhesive in the nozzle.

Embodiment 18 is the applicator assembly of Embodiment 17 further including a cylinder filled with pressurized water-based adhesive, wherein the source is the cylinder, and a hose connecting the cylinder to the inlet for pressurized adhesive in the nozzle.

Embodiment 19 is the nozzle of Embodiment 1 further including water-based adhesive flowing through the nozzle and exiting the nozzle as a focused fan of spray adhesive.

Embodiment 20 is an adhesive spray nozzle, comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive in the first end of the nozzle tip, wherein the outlet includes a spray adhesive orifice; a deflector mounted on the first end of the nozzle tip adjacent the spray adhesive outlet, wherein the deflector comprises a first angled surface and a second angled surface, wherein the first angled surface is connected to the orifice for spray adhesive so as to bisect the orifice and wherein second angled surface is connected to the orifice for spray adhesive to bisect the orifice.

Embodiment 21 is the nozzle of Embodiment 20, wherein the first angled surface and second angled surface are parallel to one another and centered relative to a centered axis A of the nozzle.

Embodiment 22 is the nozzle of Embodiment 20, wherein the nozzle has an axis A centered along the outlet for spray adhesive, and wherein the first angled surface and second angled surface are both at the same angle α measured relative to axis A.

Embodiment 23 is the nozzle of Embodiment 22, wherein the first angled surface and second angled surface are both at an angle α in the range of 5 to 10 degrees relative to the centered axis A.

Embodiment 24 is the nozzle of Embodiment 23, wherein the first angled surface and second angled surface are both at an angle α in the range of 7 to 10 degrees relative to the centered axis A.

Embodiment 25 is the nozzle of Embodiment 20, wherein the spray adhesive orifice is in the shape of a slit.

Embodiment 26 is the nozzle of Embodiment 25, wherein the spray adhesive orifice slit is in the shape of a hyperbolic paraboloid slit.

Embodiment 27 is the nozzle of Embodiment 26, wherein the nozzle has an axis A centered along the hyperbolic paraboloid slit orifice, and wherein the first angled surface and second angled surface are both at an angle α in the range of 5 to 10 degrees relative to the centered axis A.

Embodiment 28 is the nozzle of Embodiment 27, wherein the hyperbolic paraboloid slit orifice has a horizontal axis in the range of 0.035 to 0.045 inches (0.0889 to 0.1143 cm) and has vertical axis of 0.015 to 0.025 inches (0.0381 to 0.0635 cm) at its widest measurement.

Embodiment 29 is the nozzle of Embodiment 20, wherein the first and second angled surface both have a length L measured from the orifice of 0.010 to 0.020 inches (0.0254 to 0.0508 cm).

Embodiment 30 is the nozzle of Embodiment 20, wherein the deflector includes a first front surface on the first portion and a second front surface on the second portion, and wherein the first front surface and second front surface are normal to a centered axis A of the nozzle.

Embodiment 31 is the nozzle of Embodiment 20, wherein the first angled surface and second angled surface are mirror images of one another, and centered relative to an axis A of the nozzle.

Embodiment 32 is the nozzle of Embodiment 20 further comprising an adhesive conduit, wherein the inlet for pressurized adhesive is within the adhesive conduit, wherein the adhesive conduit includes a first curved surface and a second curved surface for restricting the flow of pressurized adhesive into the barrel.

Embodiment 33 is the nozzle of Embodiment 32, wherein the first curved surface and second curved surface form a slit therebetween.

Embodiment 34 is an applicator assembly comprising and applicator and the adhesive spray nozzle of Embodiment 20.

Embodiment 35 is an applicator assembly of Embodiment 34 further comprising a needle member slidably mounted inside the barrel and a trigger for moving the needle member within the barrel.

Embodiment 36 is the applicator assembly of Embodiment 20, further comprising a source of water-based pressurized adhesive, wherein the source is connected to the conduit for pressurized adhesive in the nozzle.

Embodiment 37 is the applicator assembly of Embodiment 36 further including a cylinder filled with pressurized water-based adhesive, wherein the source is the cylinder, and a hose connecting the cylinder to the inlet for pressurized adhesive in the nozzle.

Embodiment 38 is the nozzle of Embodiment 20 further including water-based adhesive flowing through the nozzle and exiting the nozzle as a focused fan of spray adhesive.

Embodiment 39 is the nozzle of Embodiment 20, wherein the first angled surface and second angled surface each include a curved portion adjacent the spray orifice.

Embodiment 40. An adhesive spray nozzle, comprising: a barrel having a first end and second end opposite the first end; a nozzle tip having a first end and a second end opposite the first end, wherein the second end of the nozzle tip is connected at a first end of the barrel; an inlet for pressurized adhesive connected within the barrel; an outlet for spray adhesive connected at a first end of the nozzle tip including a spray adhesive orifice; a deflector mounted on the first end of the nozzle tip adjacent the spray adhesive outlet, wherein the deflector comprises a first angled surface and a second angled surface, wherein the first angled surface includes a curved portion and second angled surface includes a curved portion.

Embodiment 41 is the nozzle of Embodiment 40, wherein the curved portions include radius of curvature R₃ in the range of 0.020-0.030 inches (0.0508-0.0762 cm).

Embodiment 42 is the nozzle of Embodiment 40, wherein the nozzle has an axis A centered along the outlet for spray adhesive, and wherein the first angled surface and second angled surface are both at the same angle α measured relative to axis A.

Embodiment 43 is the nozzle of Embodiment 42, wherein the first angled surface and second angled surface are both at an angle α in the range of 5 to 10 degrees relative to the centered axis A.

Embodiment 44 is the nozzle of Embodiment 43, wherein the first angled surface and second angled surface are both at an angle α in the range of 7 to 10 degrees relative to the centered axis A.

Embodiment 45 is the nozzle of Embodiment 40, wherein the spray adhesive orifice is in the shape of a slit.

Embodiment 46 is the nozzle of Embodiment 45, wherein the spray adhesive orifice slit is in the shape of a hyperbolic paraboloid slit.

Embodiment 47 is the nozzle of Embodiment 46, wherein the nozzle has an axis A centered along the hyperbolic paraboloid slit orifice, and wherein the first angled surface and second angled surface are both at an angle α in the range of 5 to 10 degrees relative to the centered axis A.

Embodiment 48 is the nozzle of Embodiment 47, wherein the hyperbolic paraboloid slit orifice has a horizontal axis in the range of 0.035 to 0.045 inches (0.0889 to 0.1143 cm) and has vertical axis of 0.015 to 0.025 inches (0.0381 to 0.0635 cm) at its widest measurement.

Embodiment 49 is the nozzle of Embodiment 40, wherein the first and second angled surface both have a length L measured from the orifice of 0.010 to 0.020 inches (0.0254 to 0.0508 cm).

Embodiment 50 is the nozzle of Embodiment 40, wherein the deflector includes a first front surface on the first portion and a second front surface on the second portion, and wherein the first front surface and second front surface are normal to a centered axis A of the nozzle.

Embodiment 51 is the nozzle of Embodiment 40, wherein the first angled surface is connected to the spray adhesive orifice so as to bisect the orifice and wherein second angled surface is connected to the orifice for spray adhesive to bisect the orifice.

Embodiment 52 is the nozzle of Embodiment 40, wherein the first angled surface and second angled surface are mirror images of one another, and centered relative to an axis A of the nozzle.

Embodiment 53 is the nozzle of Embodiment 40 further comprising an adhesive conduit, wherein the inlet for pressurized adhesive is within the adhesive conduit, wherein the adhesive conduit includes a first curved surface and a second curved surface for restricting the flow of pressurized adhesive into the barrel.

Embodiment 54 is the nozzle of Embodiment 53, wherein the first curved surface and second curved surface form a slit therebetween.

Embodiment 55 is an applicator assembly comprising and applicator and the adhesive spray nozzle of Embodiment 54.

Embodiment 56 is an applicator assembly of Embodiment 55 further comprising a needle member slidably mounted inside the barrel and a trigger for moving the needle member within the barrel.

Embodiment 57 is the applicator assembly of Embodiment 56, further comprising a source of water-based pressurized adhesive, wherein the source is connected to the conduit for pressurized adhesive in the nozzle.

Embodiment 58 is the applicator assembly of Embodiment 57 further including a cylinder filled with pressurized water-based adhesive, wherein the source is the cylinder, and a hose connecting the cylinder to the inlet for pressurized adhesive in the nozzle.

Embodiment 59 is the nozzle of Embodiment 40 further including water-based adhesive flowing through the nozzle and exiting the nozzle as a focused fan of spray adhesive.

Embodiment 60 is an adhesive spray nozzle, comprising: a barrel having a first end and second end opposite the first end; a nozzle tip having a first end and a second end opposite the first end, wherein the second end of the nozzle tip is connected at a first end of the barrel; a conduit for pressurized adhesive having an inlet and an outlet opposite the inlet, wherein the outlet is connected within the barrel, and wherein the conduit includes a first curved surface and a second curved surface for restricting the width of the outlet; an outlet for spray adhesive connected at a first end of the nozzle tip including a spray adhesive orifice.

Embodiment 61 is the nozzle of Embodiment 60, wherein the first curved surface and second curved surface form a slit therebetween for restricting the flow of pressurized adhesive into the barrel.

Embodiment 62 is the nozzle of Embodiment 60 further comprising a deflector mounted on the first end of the nozzle tip adjacent the spray adhesive outlet, wherein the deflector comprises a first angled surface and a second angled surface, wherein the first angled surface and second angled surface are configured to impinge upon the adhesive spray exiting the outlet for spray adhesive.

Embodiment 63 is the nozzle of Embodiment 62, wherein the nozzle has an axis A centered along the outlet for spray adhesive, and wherein the first angled surface and second angled surface are both at the same angle α measured relative to axis A.

Embodiment 64 is the nozzle of Embodiment 63, wherein the first angled surface and second angled surface are both at an angle α in the range of 5 to 10 degrees relative to the centered axis A.

Embodiment 65 is the nozzle of Embodiment 64, wherein the first angled surface and second angled surface are both at an angle α in the range of 7 to 10 degrees relative to the centered axis A.

Embodiment 66 is the nozzle of Embodiment 60, wherein the spray adhesive orifice is in the shape of a slit.

Embodiment 67 is the nozzle of Embodiment 66, wherein the spray adhesive orifice slit is in the shape of a hyperbolic paraboloid slit.

Embodiment 68 is the nozzle of Embodiment 62, wherein the nozzle has an axis A centered along the hyperbolic paraboloid slit orifice, and wherein the first angled surface and second angled surface are both at an angle α in the range of 5 to 10 degrees relative to the centered axis A.

Embodiment 69 is the nozzle of Embodiment 68, wherein the hyperbolic paraboloid slit orifice has a horizontal axis in the range of 0.035 to 0.045 inches (0.0889 to 0.1143 cm) and has vertical axis of 0.015 to 0.025 inches (0.0381 to 0.0635 cm) at its widest measurement.

Embodiment 70 is the nozzle of Embodiment 62, wherein the first and second angled surface both have a length L measured from the orifice of 0.010 to 0.020 inches (0.0254 to 0.0508 cm).

Embodiment 71 is the nozzle of Embodiment 62, wherein the deflector includes a first front surface on the first portion and a second front surface on the second portion, and wherein the first front surface and second front surface are normal to a centered axis A of the nozzle.

Embodiment 72 is the nozzle of Embodiment 62, wherein the first angled surface is connected to the spray adhesive orifice so as to bisect the orifice and wherein second angled surface is connected to the orifice for spray adhesive to bisect the orifice.

Embodiment 73 is the nozzle of Embodiment 62, wherein the first angled surface and second angled surface are mirror images of one another, and centered relative to an axis A of the nozzle.

Embodiment 74 is an applicator assembly comprising and applicator and the adhesive spray nozzle of Embodiment 60.

Embodiment 75 is an applicator assembly of Embodiment 74 further comprising a needle member slidably mounted inside the barrel and a trigger for moving the needle member within the barrel.

Embodiment 76 is the applicator assembly of Embodiment 74, further comprising a source of water-based pressurized adhesive, wherein the source is connected to the conduit for pressurized adhesive in the nozzle.

Embodiment 77 is the applicator assembly of Embodiment 76 further including a cylinder filled with pressurized water-based adhesive, wherein the source is the cylinder, and a hose connecting the cylinder to the inlet for pressurized adhesive in the nozzle.

Embodiment 78 is the nozzle of Embodiment 60 further including water-based adhesive flowing through the nozzle and exiting the nozzle as a focused fan of spray adhesive.

Embodiment 79 is a method of spraying adhesive, comprising: supplying pressurized adhesive; propelling the pressurized adhesive down a conduit to form a first adhesive flow path; impinging the pressurized adhesive with a first curved surface and a second curved surface with an open slit therebetween, whereby the pressurized adhesive exits the conduit through the slit; thereafter propelling the pressurized adhesive through a second conduit to form a second adhesive flow path; impinging the pressurized adhesive with a first angled surface and a second angled surface with a slit therebetween; and forming a focused fan-shaped spray of pressurized adhesive.

Embodiment 80 is the method of Embodiment 79, further comprising reducing the flow of the pressurized adhesive as it passes through the open slit formed between the first curved surface and the second curved surface.

Embodiment 81 is the method of Embodiment 80, further comprising providing a nozzle including the first angled surface and the second angled surface and reducing the flow of the pressurized adhesive as it passes through a conical portion and a spherical tip in the nozzle.

Embodiment 82 is the method of Embodiment 81, The nozzle of Embodiment 1, wherein the nozzle has an axis A centered along an outlet for spray adhesive, and wherein the first angled surface and second angled surface are both at the same angle α measured relative to axis A.

Embodiment 83. The method of Embodiment 82, wherein the first angled surface and second angled surface are both at an angle α in the range of 5 to 10 degrees relative to the centered axis A.

Embodiment 84 is the method of Embodiment 81, wherein a nozzle includes a spray adhesive orifice in the shape of a hyperbolic paraboloid slit.

Embodiment 85 is the method of Embodiment 80 further providing a cylinder filled with pressurized water-based adhesive and providing a hose connecting the cylinder to the nozzle.

What is claimed is:

1. A barrel for an adhesive spray nozzle comprising:
an adhesive conduit comprising an inlet;
a barrel conduit in fluid communication with the adhesive conduit;
a tip portion comprising an outlet;
a flow path passing from the inlet, through the adhesive conduit, into the barrel conduit, and into the tip portion to the outlet;
wherein the flow path is restricted between the adhesive conduit and the barrel conduit to restrict the flow of a pressurized adhesive.

2. The barrel of claim 1 wherein the adhesive conduit comprises an inner surface that narrows to a slit to restrict the flow path between the adhesive conduit and the barrel conduit.

3. The barrel of claim 2 wherein the slit is formed between a first surface and a second surface, wherein the slit comprises a horizontal axis and a vertical axis.

4. The barrel of claim 3 wherein a widest distance D6 along the vertical axis between the first surface and the second surface is in a range from 0.0762 cm to 0.127 cm.

5. The barrel of claim 3 wherein a narrowest distance D5 along the vertical axis between the first surface and the second surface is in a range from 0.0635 cm to 0.0889 cm.

6. The barrel of claim 3 wherein a distance D4 along the horizontal axis is in a range from 0.381 cm to 0.635 cm.

7. The barrel of claim 3 wherein the slit has a uniform width.

8. The barrel of claim 3 wherein the first surface and second surface are curved surfaces.

9. The barrel of claim 8 wherein the first surface comprises a radius R_{A} in a range from 0.254 cm to 0.508 cm and the second surface comprises a radius R_{B} in a range from 0.254 cm to 0.508 cm.

10. The barrel of claim 1 wherein the barrel conduit comprises a center axis A, wherein the adhesive conduit is positioned at an angle to axis A.

11. The barrel of claim 10 wherein the adhesive conduit is perpendicular to center axis A.

12. The barrel of claim 10 wherein the barrel conduit is sized to receive a needle member along center axis A.

13. The barrel of claim 12 wherein the barrel conduit comprises surfaces configured to seal against the needle member to shut off the flow of a pressurized adhesive.

14. The barrel of claim 13 wherein the barrel conduit comprises a cylindrical inner surface that tapers to a conical portion, wherein the conical portion comprises the surfaces configured to seal against the needle member.

15. The barrel of claim 13, wherein the adhesive conduit comprises an inner surface that narrows to a slit to restrict the flow path between the adhesive conduit and the barrel conduit, wherein the slit is formed between a first surface and a second surface, wherein the slit is semicircular in shape where it intersects with the barrel conduit.

16. A barrel for an adhesive spray nozzle comprising:
an adhesive conduit comprising an inlet and an inner surface;
a barrel conduit in fluid communication with the adhesive conduit, wherein the barrel conduit:
is sized to receive a needle member along a center axis A; and
comprises surfaces configured to seal against the needle member to shut off the flow of a pressurized adhesive;
a tip portion comprising an outlet;
a flow path passing from the inlet, through the adhesive conduit, into the barrel conduit, and into the tip portion to the outlet;
wherein the adhesive conduit is positioned at an angle to center axis A and the inner surface of the adhesive conduit narrows to a slit to restrict the flow path between the adhesive conduit and the barrel conduit.

17. The barrel of claim 16 wherein the slit is formed between a first surface and a second surface, wherein the slit comprises a horizontal axis and a vertical axis, wherein:
a widest distance D6 along the vertical axis between the first surface and the second surface is in a range from 0.0762 cm to 0.127 cm;
a narrowest distance D5 along the vertical axis between the first surface and the second surface is in a range from 0.0635 cm to 0.0889 cm; and
a distance D4 along the horizontal axis is in a range from 0.381 cm to 0.635 cm.

18. The barrel of claim 16 wherein the slit has a uniform width.

19. The barrel of claim 16 wherein the first surface and second surface are curved surfaces.

20. The barrel of claim 19 wherein the first surface comprises a radius R_{A} in a range from 0.254 cm to 0.508 cm and the second surface comprises a radius R_{B} in a range from 0.254 cm to 0.508 cm.
